(19) United States
(12) Patent Application Publication
(10) Pub. No.: US 2026/0023236 A1
(43) Pub. Date: Jan. 22, 2026

(54) MULTI-METAL CONDUCTOR UNDERSEA CABLE AND METHOD OF MANUFACTURE

(71) Applicant: SUBCOM, LLC, Eatontown, NJ (US)

(72) Inventor: Gregory Bubel, Middletown, NJ (US)

(73) Assignee: SUBCOM, LLC, Eatontown, NJ (US)

(21) Appl. No.: 18/779,642

(22) Filed: Jul. 22, 2024

(51) Int. Cl. G02B 6/44

(52) U.S. Cl. CPC G02B 6/4488; G02B 6/4416; G02B 6/4427

(57) ABSTRACT

Disclosed is a cable with multimetallic conductor structure. In some embodiments, a method of forming an optical cable may include providing a buffer tube around a plurality of optical fibers, providing a plurality of layered strength members around the buffer tube, and forming a conductive conduit around the plurality of layered strength members. The conductive conduit may include a multimetallic strip of a first metal layer and a second metal layer and, if beneficial, further layers, wherein forming the conductive conduit comprises bending the multimetallic strip from a flat configuration to a cylindrical configuration, and/or applying a metal layer via an electrolytic or hot dip process. The method may further include forming an outer insulating jacket surrounding the conductive conduit.

### BACKGROUND OF THE INVENTION

### Discussion of Related Art

Submarine cables intended to be used in optical fiber undersea cable system with submerged repeaters (i.e., undersea bodies that house optical amplifiers and network power supplies) and/or other electrical power consuming undersea bodies have an electrical conductor to carry power from the shore to these undersea bodies. This cable conductor is insulated from the sea water ground by a layer of extruded insulation, typically polyethylene. The conductor layer should have sufficiently low electrical resistance (i.e., high conductance) to minimize resistive power dissipation and ensure that sufficient power can be delivered to the undersea power-consuming elements of the system. Having cable with low electrical resistance becomes increasingly important as capacity demands grow and optical path counts increase, which in turn increases the number of power-consuming optical amplifiers. Other power-consuming features of undersea systems also importantly benefit from the delivery of plentiful electrical power. On the other hand, undersea systems, or segments of such systems, that are shorter or have less undersea power consumption needs can be implemented with higher resistance (i.e. lower conductance) undersea cable power conductor(s).

Historically, undersea cables have utilized pure copper as the material for power conductors in order to reduce resistive power dissipation. Copper can be readily welded into a hermetic tube, protecting the underlying fibers and steel strength wires from moisture and hydrogen. However, copper has limited strength, a minimum thickness required for processability, high cost, is subject to volatile market pricing, and high weight.

It is with respect to these and other drawbacks of the prior art that the present disclosure is provided.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

In one approach, a method of forming an optical cable may include providing a buffer tube around a plurality of optical fibers, providing a plurality of layered strength members around the buffer tube, and forming a conductive conduit around the plurality of layered strength members. The conductive conduit may include a multimetallic strip of a first metal layer and a second metal layer, wherein forming the conductive conduit comprises bending the multimetallic strip from a flat configuration to a cylindrical configuration. The method may further include forming an outer insulating jacket surrounding the conductive conduit.

In another approach, a method of forming an optical cable may include providing a buffer tube around a plurality of optical fibers, providing a plurality of layered strength members around the buffer tube, and forming a conductive conduit around the plurality of layered strength members, wherein the conductive conduit comprises a first metal layer and a second metal layer atop the first metal layer, wherein the first metal layer is bent from a flat configuration to a cylindrical configuration, and wherein the second metal layer is electroplated over the first metal layer. The method may further include forming an outer insulating jacket surrounding the conductive conduit.

In still yet another approach, a method of forming an undersea optical cable, may include providing a buffer tube around a plurality of optical fibers, providing a plurality of layered strength members around the buffer tube, and wrapping a multimetallic strip around the plurality of layered strength members. The multimetallic strip may include a first metal layer and a second metal layer, wherein the multimetallic strip has a first edge and a second edge on opposite sides of a central longitudinal axis, and wherein the multimetallic strip is bent around the plurality of layered strength members until the first edge is parallel to, and abuts, the second edge. The method may further include forming an outer insulating jacket surrounding the conductive conduit.

### BRIEF DESCRIPTION OF THE DRAWINGS

By way of example, embodiments of the disclosure will now be described, with reference to the accompanying drawings, in which:

FIG. 1 illustrates an example optical fiber undersea cable system according to embodiments of the present disclosure;

FIG. 2A illustrates an exemplary undersea cable according to embodiments of the present disclosure;

FIG. 2B illustrates an exemplary undersea cable according to embodiments of the present disclosure; and

FIGS. 3A-3C depict an undersea cable during a manufacturing process according to embodiments of the present disclosure.

Furthermore, certain elements in some of the figures may be omitted, or illustrated not-to-scale, for illustrative clarity. The cross-sectional views may be in the form of “slices”, or “near-sighted” cross-sectional views, omitting certain background lines otherwise visible in a “true” cross-sectional view, for illustrative clarity. Furthermore, for clarity, some reference numbers may be omitted in certain drawings.

### DESCRIPTION OF EMBODIMENTS

The present disclosure will now be described more fully hereinafter with reference to the accompanying drawings, in which preferred embodiments of the invention are shown. This disclosure, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

The present disclosure is directed to an improved undersea optical fiber cable having a multi-metal conductor surrounding a plurality of optical fibers, and methods for forming said cable. The prior art approaches described above with single metal cable structural layers creates either a more constrained (thus potentially less optimized) design with a single layer, or more complex manufacturing associated with individual metal layers applied separately. To address these deficiencies, embodiments of the present disclosure are directed to a cable structure with a bimetal, trimetal, or multimetal (e.g., with an arbitrary number of layers) conductor formed by bending the multimetallic strip from a flat configuration to a cylindrical configuration about the optical fibers in a single processing step.

Alternatively, the metal layers may be applied in line with a power conductor process. For example, the possible material implementation of soft steel with zinc plating could be achieved by electroplating a thin layer of zinc over a pure steel strip material as part of the power conductor line manufacturing step, which may be a continuous process operated over long lengths.

Advantageously, the present disclosure provides a multimetallic layered strip material for the formation of cable power conductors as a means to expand cable design freedom without additional cable manufacturing processing steps. The expanded cable design space provides a means to better optimize the combination of characteristics important to a good undersea cable product for a given application. For a given cable application, the characteristics of interest may include one or more of the following: strength of the power conductor cylinder itself and/or of the cable, stabilization of the strength wires within the power conductor cylinder, ease of welding or other cable manufacture processing, increased cable production throughput, optimized weight, optimized electrical resistance, lower cost, less dependence on volatile market prices of some metals, greater material stability and compatibility, benefits to the design of cable joints, etc.

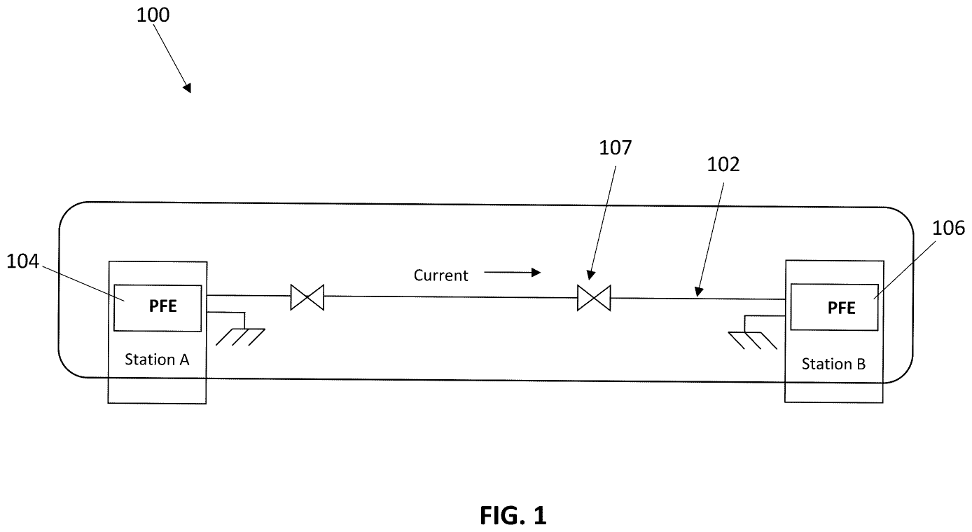

Turning to the figures, FIG. 1 illustrates one example optical fiber undersea cable system (hereafter “system”) 100 in accordance with an embodiment of the present disclosure. The system 100 is shown in a highly simplified form for ease of description. As shown, the system 100 includes a dual-end submarine fiber optic cable (hereinafter “cable”) 102 powered by a first local power feed equipment (PFE) 104 and a second PFE 106. The PFEs 104 and 106 may be located at opposite cable landing stations, (e.g., Station A and Station B). Each of the PFEs 104, 106 may be configured to supply, for example, up to 23 kW. The system may also be configured for powering from a single PFE. Embodiments herein are not limited to any particular power limits, however. A plurality of additional power consuming undersea system elements 107 may be provided between PFEs 104 and 106.

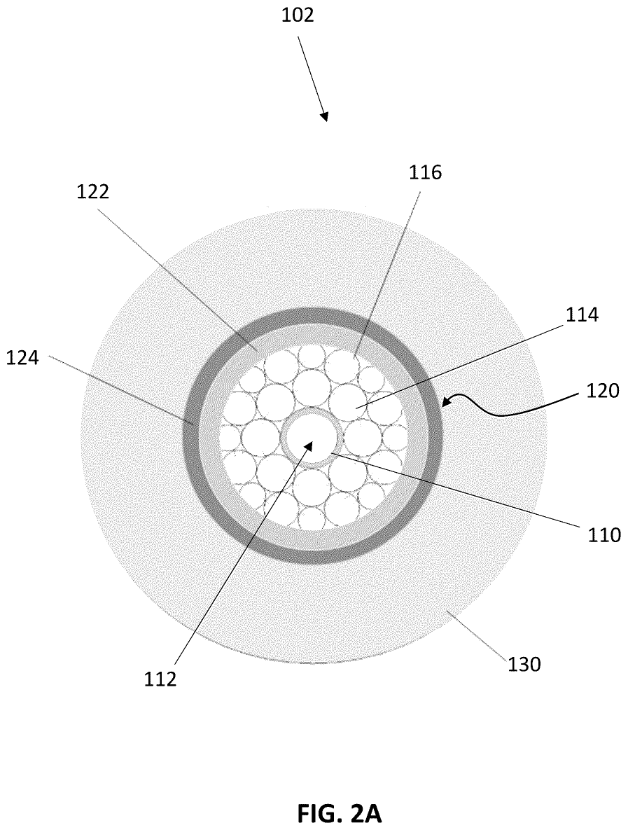

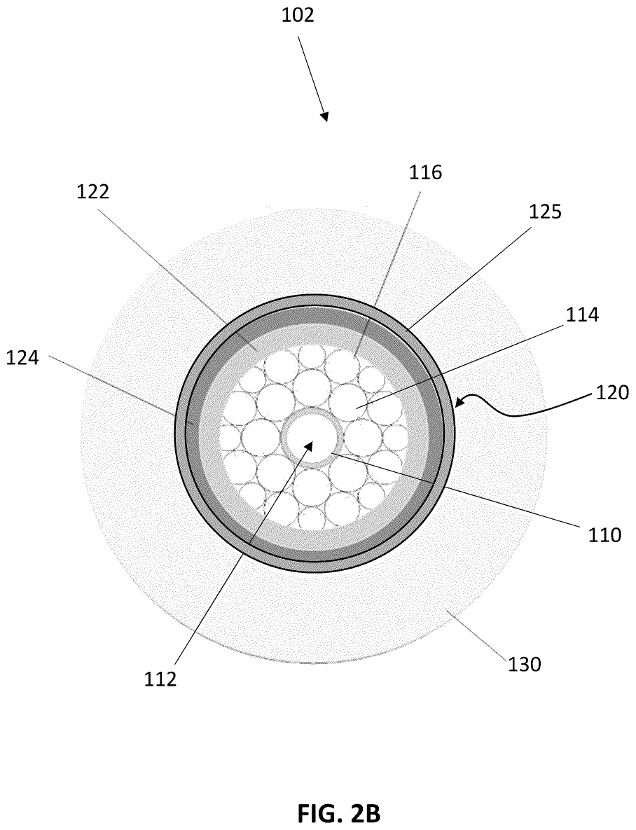

FIG. 2A illustrates a cross sectional view of an example cable, such as the submarine fiber optic cable 102 shown in FIG. 1. As shown, a tube 110 may enclose or include a plurality of optical fibers 112 therein. The tube 110 may be a single, centrally located gel-filled buffer tube made from plastic material or welded metal. As further shown, a first layer 114 and a second layer 116 of strength members may be wound around the tube 110. For example, the strength members may have a circular cross-section and each layer of the strength members may be arranged in a close-packed configuration, e.g., the inner, first layer 114 may comprise eight (8) strength members in which adjacent strength members are in contact with one another. Similarly, the outer, second layer 116 may comprise sixteen (16) strength members in which adjacent members are in contact with one another. Other numbers and arrangements of strength members, for example 10 and 20 for first and second layers, respectively, are also possible in alternative embodiments.

As further shown, a conductor 120 may surround the first and second layers 114, 116 of strength members and may serve as both an electrical conductor and a hermetic barrier. In some embodiments, the conductor 120 may include a first layer 122 surrounded by a second layer 124. Although non-limiting, the first layer 122 may be aluminum, while the second layer 124 may be copper or steel. In other embodiments, the first layer 122 may be a relatively soft steel and the second layer 124 may be zinc or copper. Innumerable other combinations of metal types, number of layers, and their order in the strip material of the conductor 120, are also possible. For example, in the non-limiting embodiment shown in FIG. 2B, the conductor 120 may be a trimetallic strip in which a third layer 125 surrounds the second layer 124. Although non-limiting, the third layer 125 may be steel, copper, zinc, or other metal.

As demonstrated, the first and second layers 122, 124 (and optionally third layer 125) may be in direct physical and electrical contact with one another. In some embodiments, the first and second layers 122, 124 may be connected as part of a multimetallic strip, such as a bimetallic or trimetallic strip. The multiple layers may be joined together by any suitable conventional process, such as cladding. The conductor 120 may be manufactured by forming a flat layer or sheet of two or more materials into a tube with a longitudinal seam and welding the seam to form a continuous joint.

In the embodiment shown, the volume of the first layer 122 and the second layer 124 are approximately the same while the radial thickness of the first layer 122 is slightly larger than a radial thickness of the second layer 124. However, the relative thicknesses between the first and second layers 122, 124 may vary in other embodiments. In still other embodiments, the radial thicknesses of the first and second layers 122, 124 may be approximately the same or may be quite different.

Further illustrated is an outer jacket 130 that is formed from polyethylene, or other dielectric material, and may encapsulate the conductor 120. For example, the outer jacket 130 may serve as an electrical insulating layer. The outer jacket 130 may be extruded over the conductor 120.

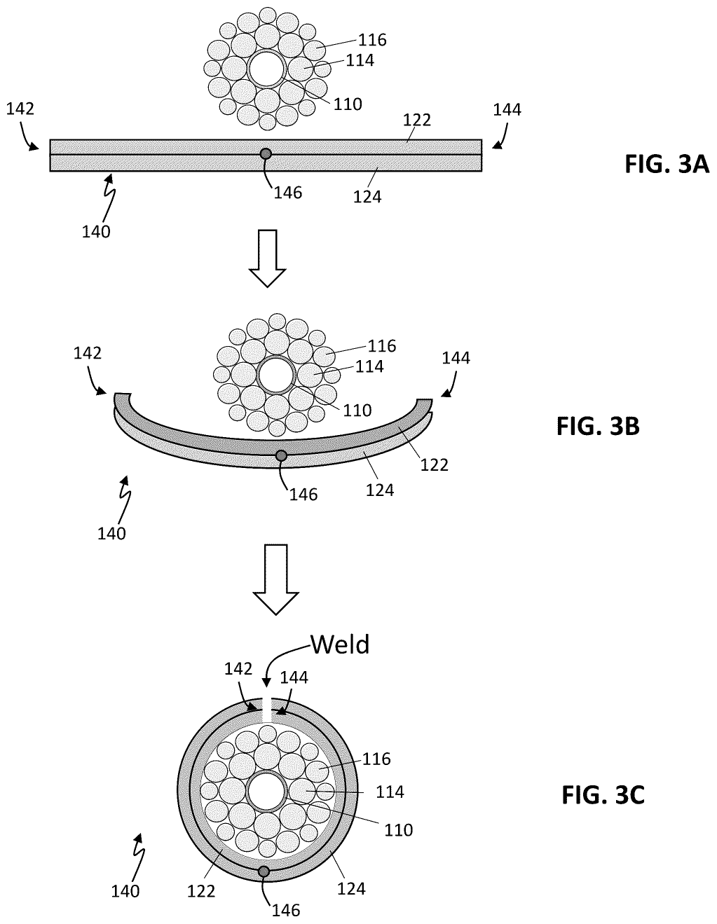

FIGS. 3A-3C demonstrate one approach for forming the submarine fiber optic cable 102 shown in FIG. 2. As shown in FIG. 3A, the tube 110 and the first and second strength layers 114, 116 may be positioned adjacent a multimetallic strip 140, which includes the first layer 122 atop the second layer 124. The multimetallic strip 140 has a first edge 142 and a second edge 144 on opposite sides of a central longitudinal axis 146. The first edge 142 and the second edge 144 generally run parallel to one another along an entire length of the multimetallic strip 140.

As shown in FIG. 3B, the multimetallic strip 140 may then be formed about the first and second strength layers 114, 116. In one non-limiting example, one or more supply reels may deliver the multimetallic strip 140 and the first and second strength layers 114, 116 into a tube forming apparatus, which bends the multimetallic strip 140 and forces the first edge 142 and the second edge 144 towards the first and second strength layers 114, 116. A thermal treatment may be applied to the multimetallic strip 140 as the multimetallic strip 140 passes through the tube forming apparatus. The multimetallic strip 140 and the first and second strength layers 114, 116 may continue through the tube forming apparatus until the first edge 142 and the second edge 144 are parallel to, and abut, one another, as shown in FIG. 3C.

In some embodiments, the output of the tube forming apparatus may then be fed into a welder, which joins together the first edge 142 and the second edge 144 to form the conductor 120. The output of the welder may then be fed into an extruder, which forms the outer insulating jacket 130 around the conductor 120.

In an alternative embodiment, the second layer 124 may be electroplated over the first layer 122. For example, the first layer 122 may be a strip of soft steel and the second layer 124 may be zinc, which is electroplated over the steel strip as part of the power conductor line manufacturing process. Electroplating is the process of using electrical current to coat an electrically conductive object, in this case steel strip, with a relatively thin layer of metal to provide corrosion protection, a ductile layer, and/or lubricity on the steel strip surface. For corrosion protection, zinc may coat the steel strip by immersion in molten zinc bath (e.g., hot dip process) or electrolytically.

In sum, the potential benefits of a power conductor formed from multi-metal strip material (in which one of the metals may or may not be copper), for a given cable application may include one or more of the following: higher strength (of the power conductor cylinder itself and/or of the cable), more favorable stabilization of the strength wires within the power conductor cylinder, ease of welding or other cable manufacture processing, increased cable production throughput, optimized weight, optimized electrical resistance, lower cost, less dependence on volatile market prices of some metals, greater material stability and compatibility, benefits to the design of cable joints, and other characteristics important to cable product design. Furthermore, the additional design freedom created, without additional cable manufacturing processing steps (exception being electrolytic layer addition described above), affords cable designers a larger design space in which to optimize the combination of characteristics important to a good undersea cable product for a given application.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The use of “including,” “comprising,” or “having” and variations thereof herein is meant to encompass the items listed thereafter and equivalents thereof as well as additional items. Accordingly, the terms “including,” “comprising,” or “having” and variations thereof are open-ended expressions and can be used interchangeably herein.

The phrases “at least one”, “one or more”, and “and/or”, as used herein, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

Furthermore, identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings attached hereto may vary.

The terms “substantial” or “substantially,” as well as the terms “approximate” or “approximately,” can be used interchangeably in some embodiments, and can be described using any relative measures acceptable by one of ordinary skill in the art. For example, these terms can serve as a comparison to a reference parameter, to indicate a deviation capable of providing the intended function. Although non-limiting, the deviation from the reference parameter can be, for example, in an amount of less than 1%, less than 3%, less than 5%, less than 10%, less than 15%, less than 20%, and so on.

Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of forming an optical cable, comprising:
providing a buffer tube around a plurality of optical fibers;
providing a plurality of layered strength members around the buffer tube;
forming a conductive conduit around the plurality of layered strength members, wherein the conductive conduit comprises a multimetallic strip of a first metal layer and a second metal layer, and wherein forming the conductive conduit comprises bending the multimetallic strip from a flat configuration to a cylindrical configuration; and
forming an outer insulating jacket surrounding the conductive conduit.

2. The method of claim 1, wherein the multimetallic strip has a first edge and a second edge on opposite sides of a central longitudinal axis, and wherein forming the conductive conduit comprises bending the multimetallic strip until the first edge abuts the second edge.

3. The method of claim 2, further comprising welding together the first and second edges.

4. The method of claim 1, wherein the first metal layer is aluminum, and wherein the second metal layer is copper or steel.

5. The method of claim 1, wherein the first metal layer is steel, and wherein the second metal layer is zinc or copper.

6. The method of claim 1, wherein the conductive conduit is formed directly adjacent the plurality of layered strength members.

7. The method of claim 1, wherein the conductive conduit is formed directly adjacent the outer insulating jacket.

8. A method of forming an optical cable, comprising:
providing a buffer tube around a plurality of optical fibers;
providing a plurality of layered strength members around the buffer tube;
forming a conductive conduit around the plurality of layered strength members, wherein the conductive conduit comprises a first metal layer and a second metal layer atop the first metal layer, wherein the first metal layer is bent from a flat configuration to a tubular configuration, and wherein the second metal layer is electroplated over the first metal layer; and
forming an outer insulating jacket surrounding the conductive conduit.

9. The method of claim 8, wherein the first metal strip has a first edge and a second edge on opposite sides of a central longitudinal axis, and wherein forming the first metal layer comprises bending the first metal layer until the first edge abuts the second edge.

10. The method of claim 9, further comprising welding together the first and second edges.

11. The method of claim 10, wherein the second metal layer is electroplated along an exterior of the first metal strip after the first and second edges are welded together.

12. The method of claim 10, wherein the second metal layer is electroplated along an exterior of the first metal strip before it is formed into a cylinder.

13. The method of claim 8, wherein the first metal layer is steel, and wherein the second metal layer is zinc or copper.

14. The method of claim 8, wherein the conductive conduit is formed directly adjacent the plurality of layered strength members.

15. The method of claim 8, wherein the conductive conduit is formed directly adjacent the outer insulating jacket.

16. A method of forming an undersea optical cable, the method comprising:
providing a buffer tube around a plurality of optical fibers;
providing a plurality of layered strength members around the buffer tube;
wrapping a multimetallic strip around the plurality of layered strength members, wherein the multimetallic strip comprises a first metal layer and a second metal layer, wherein the multimetallic strip has a first edge and a second edge on opposite sides of a central longitudinal axis, and wherein the multimetallic strip is bent around the plurality of layered strength members until the first edge is parallel to, and abuts, the second edge; and
forming an outer insulating jacket surrounding the multimetallic strip.

17. The method of claim 16, further comprising welding together the first and second edges of the multimetallic strip.

18. The method of claim 16, wherein the first metal layer is aluminum, and wherein the second metal layer is copper or steel.

19. The method of claim 16, wherein the first metal layer is steel, and wherein the second metal layer is zinc or copper.

20. The method of claim 16, wherein the multimetallic strip is formed directly adjacent the plurality of layered strength members, and wherein the outer insulating jacket is formed directly atop the multimetallic strip.
